(19) United States
(12) Patent Application Publication
(10) Pub. No.: US 2010/0258973 A1
(43) Pub. Date: Oct. 14, 2010

(54) Method For Forming A Textured Panel

(75) Inventors: Fritz SCHWEINDL, Muhldorf (DE); Norbert GLAESER, Kraiburg (DE)

Correspondence Address: GROSSMAN, TUCKER, PERREAULT & PFLEGER, PLLC, 55 SOUTH COMMERICAL STREET, MANCHESTER, NH, 03101, US

(73) Assignee: International Automotive Components Group North America, Inc., Dearborn, MI (US)

(21) Appl. No.: 12/423,450

(22) Filed: Apr. 14, 2009

(51) Int. Cl. B29C 43/20

(52) U.S. Cl. 264/257

(57) ABSTRACT

A molding process for forming a grained trim panel having improved haptics is provided. A relatively soft ungrained skin may be placed into a relatively cool textured compression mold and a heated web of mixed synthetic and natural fibers placed onto the skin. The mold may be closed and the web compressed at about 100-300 N/square centimeter causing a panel to be formed in a single process that includes an integrally formed texture and a substrate layer.

### FIELD

The present invention relates to the manufacture of grained panels for interior trim wherein the grain or texture on the outer surface of the soft skin may be created during the molding process, wherein the panels include a fiber backing.

### BACKGROUND

Decorative trim panels for the interior of vehicles often comprise hard injection molded plastic having a textured surface. For more luxurious vehicles, a softer feel and appearance may be desired. This may be accomplished by calendaring or casting a separate relatively softer textured skin which may then be backed with a foam layer and a reinforcing substrate. To provide soft trim panels for applications such as seat backs, console bases, or door panels, the manufacturing process may generally involve three separate processes, 1) forming a textured skin, 2) forming a substrate layer and 3) placing the skin and substrate into a third mold and pouring urethane foam precursors between them to integrate the skin and substrate into a molded panel. This may involve numerous molds and a substantial amount of labor.

A relatively new area of consideration in which automobile manufacturers may attempt to please consumers is an area called haptic technology. Haptics may generally be defined as the science of applying touch (tactile) sensation and control to interaction with computer applications. In automotive applications, the term relates to the sense of touch when contacting the surface of an interior trim panel and whether the surface of the panel feels warm or cool, soft or hard and textured or smooth. Panels which are sensed to be warm, soft and textured are believed to provide a more positive response from the consumer than panels which may be hard, cold and smooth surfaced.

### SUMMARY

In a first aspect, the present disclosure is directed at a method for forming a textured trim panel in a single molding step, comprising providing a compression mold having a textured or grained cavity, providing an untextured polymeric skin, and providing a web of natural and synthetic fibers. This may be followed by heating the web of natural and synthetic fibers to a temperature between the glass transition temperature and the melt temperature of the synthetic fibers and placing the untextured polymeric skin into the textured cavity surface of the compression mold. This may be followed by placing the heated web onto the polymeric skin, closing the compression mold and compressing the web and the skin to a thickness in the range of about 1.0 mm to 5.0 mm. This may then be followed by demolding a trim panel having a textured or grained skin and a fibrous substrate layer.

In another aspect, the present disclosure is directed at a trim panel molded by the above-described process.

### BRIEF DESCRIPTION OF THE DRAWINGS

The accompanying drawings, which are incorporated in and constitute a part of the specification, illustrate embodiments of the invention and, together with the description, serve to explain principles of the invention.

FIG. 1 is a block diagram of the process according to the present disclosure for forming a trim panel.

### DETAILED DESCRIPTION

The present invention now is described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

The present disclosure is directed at a compression molding process for forming a grained trim panel having a soft warm textured feel. The textured panel may include a fiber backing which provides improved mechanical strength, wherein the fibers are applied to the panel in a compression molding operation, where the fibers may be preheated.

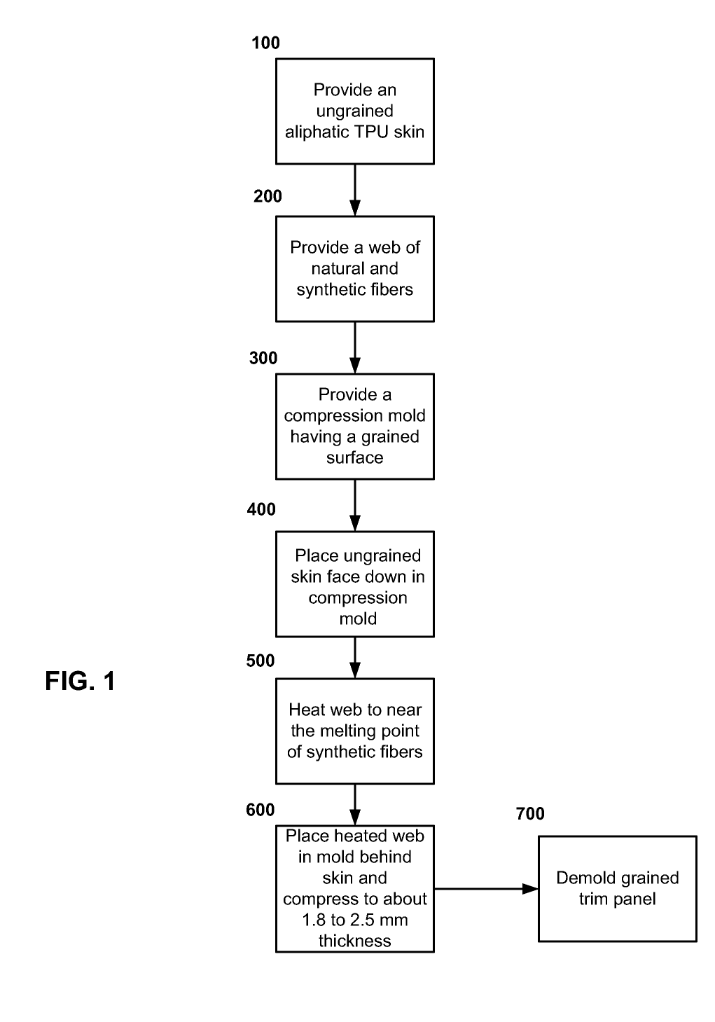

The process is described in block form in FIG. 1. As shown in Block 100, a relatively low durometer skin may be provided having a thickness in the range of about 0.3 to about 1.5 mm., preferably about 0.5 mm to about 0.8 mm. Generally, the skin may have a Shore A hardness in the range of about 60 A to about 90 A, wherein the lower values may generally provide improved haptics. The skin may be prepared by casting, sintering or calendaring, for instance, an aliphatic thermoplastic urethane having a relatively smooth surface (without a surface texture or grain).

Aliphatic thermoplastic polyurethanes may be preferred as they provide a rather warm natural feel rather than a cold “plastic” feel. This may be because the TPU skin removes less heat upon contact with the skin than other plastic materials due to its heat capacity. The skin is provided without a grain or texture as one or more textures or grains may be imparted to the surface of the skin by the surface of the compression mold during the molding process. Other polymers which may find use in the process described herein, but having somewhat different haptics, may include, but not be limited to, polyolefin (TPO), polyvinylchloride (PVC) and blends of aliphatic and aromatic thermoplastic polyurethane (TPU).

In addition, the skin may comprise two layers of TPU, with a thin layer of aliphatic polyurethane covering a base layer of aromatic polyurethane, the aliphatic provide the weathering resistance required and the aromatic providing heat resistance. Reference to aliphatic herein, therefore to an aliphatic diisocyanate, is reference to a diisocyanate that contains, for example, only hydrocarbon functionality, for example, the use of an isocyanate such as hexamethylene diisocyanate or (HMDI). The aliphatic TPU is therefore one that may be formulated specifically to optimize weatherability, and as a consequence, it may preferably employ aliphatic functionality. The overall level of aliphatic functionality may therefore be greater than 75% (wt.) and fall within the range of 75-100% (wt). A completely (100% wt.) aliphatic polyurethane would therefore include a polyurethane that relies upon an aliphatic diisocyanate, an aliphatic polyol (e.g., aliphatic polyether or polyester) and an aliphatic chain extender. The aliphatic polyurethane so prepared may also be prepared in the presence of a urethane catalyst.

Accordingly, any suitable aliphatic organic diisocyanate, or mixture of diisocyanates, may be used in the skin forming process of the present invention. Representative examples of suitable organic diisocyanates may include, isophorone diisocyanate (IPDI), hexamethylene diisocyanate (HDI), hydrogenated MDI, hydrogenated XDI, cyclohexane diisocyanate, mixtures and derivatives thereof and the like. The aliphatic diisocyanates can be present in amounts ranging from about 20% to about 50% but are preferably present in amounts in the range of approximately 25% to 40% (by wt.).

Accordingly, the base layer may comprise a base polyol component similar to that used in the formulation for the outer layer together with a relatively lower cost aromatic isocyanate such as diphenylmethane diisocyanate. A cycloaliphatic (secondary) amine may be added to provide urea linkages and improve the retention of physical properties after heat aging.

At Block 200, a web of fibers may be provided to be used as the substrate in the trim panel. The web may be sourced from either natural or synthetic fibers. The web of fibers may be, for instance, a needle-punched or hydroentangled blend of natural and synthetic fibers in a nonwoven configuration. The natural fibers may comprise, for instance, cellulose, lignocellulose, hemp, sisal, etc. The synthetic fibers may comprise, for instance, polypropylene, polyester (for instance, PET), polyethylene or combinations thereof. Generally, the web of fibers will comprise weight ratios of fibers in the range from about 20% polypropylene to about 80% polypropylene. The web may have a basis weight in the range from about 1400 to about 2000 grams per square meter and have a thickness of about 10-15 mm. before compression. The fibers (synthetic and/or natural) may act as a binder in the molding process to adhere the web of fibers together, as well as to adhere the skin to the formed substrate of molded fibers.

At Block 300, a compression mold may be provided for forming the trim panel, the mold being of metal construction and, more particularly steel, vapor deposited nickel or electroformed nickel. The surface of the cavity of the compression mold may have one or more textures or grains or other decorative patterns formed thereon which may be imparted to the aliphatic thermoplastic polyurethane skin in the compression molding process. The mold may be operated in the range of about 40° C. to about 60° C. The surface of the mold may further include one or more vent holes.

By mold texture, it is understood to mean the visual or tactile surface characteristics and appearance of the mold surface, generally in a regular or repeating pattern. By grain, it is understood to mean that the mold surface may be a reproduction of the treated surface of an animal skin.

At Block 400, the ungrained or untextured skin may be placed face down into the compression mold. This may be followed by (Block 500) heating the web of natural and synthetic fibers to a temperature between the glass transition temperature (Tg) and the melting temperature (Tm) of the fibers. In the case of polypropylene, the Tm may be in the range of about 170° C. to about 220° C. The skin may also be heated to a temperature to assist in transferring the texture from the mold surface into the skin surface.

It may be appreciated that by heating at a temperature at or above Tg, and below Tm, one may provide that the fibers may ultimately adhere to each other. As noted, above, this then provides that the fibers may act as a binder with the panel layer, in the sense that the fibers and polymeric skin layer become bonded together, i.e. the fibers to one another and the fibers to the skin material.

At Block 600, the heated web may be transferred to the compression mold, placed onto the backside of the ungrained skin and the mold closed. The heat from the web and the pressure of the closed mold may then cause the grain or texture(s) from the mold surface to be imparted to the surface of the skin. The web may be compressed by the mold under a pressure in the range of about 100-300 N/square centimeter to thin the web from the 10-15 mm original thickness to a final thickness in the range of about 1.0 mm. to about 5.0 mm., preferably about 1.8 mm to about 2.5 mm. The heated polypropylene fibers may then cool and act as a binder for the web and the skin.

Following a short mold residence time, in the order of 75 seconds or so, a grained trim panel having a warm feel and an aesthetically pleasing texture may be demolded.

Such panels as described herein may find particular use in automotive applications where physical contact with a person may be possible and the surface characteristics may be appreciated by such person. This may include, for instance, door panels, close-out panels, seat back panels, glove box doors, console bases and console lids.

Such panels may include fasteners such as clips or hook (touch) fasteners molded into the construction during the compression molding process, or they may be assembled into the vehicle via vibration or ultrasonic welding.

The description and drawings illustratively set forth the presently preferred invention embodiments. The description and drawings are intended to describe these embodiments and not to limit the scope of the invention. Those skilled in the art will appreciate that still other modifications and variations of the present invention are possible in light of the above teaching while remaining within the scope of the following claims. Therefore, within the scope of the claims, one may practice the invention otherwise than as the description and drawings specifically show and describe.

What is claimed is:

1. A method for forming a textured trim panel comprising:
providing a compression mold having a textured or grained cavity;
providing an untextured or ungrained polymeric skin;
providing a web of natural and/or synthetic fibers;
heating said web of natural and/or synthetic fibers to a temperature between the glass transition temperature and the melt temperature of said fibers;
placing said untextured or ungrained polymeric skin onto said textured or grained cavity surface of said compression mold;
placing said heated web onto said polymeric skin and closing said compression mold;
compressing said web and said skin to a thickness in the range of about 1.0 mm to about 5.0 mm;
demolding a trim panel having a textured or grained skin and a fibrous substrate layer.

2. The method of claim 1 wherein said compression mold comprises one of steel, vapor deposited nickel or electroformed nickel.

3. The method of claim 1 wherein said cavity includes a plurality of textures.

4. The method of claim 1 wherein said cavity includes the reproduction of a grain or patterns of texturing.

5. The method of claim 1 wherein said mold is operated at about 40° C. to about 60° C. and at about 100 to about 300 N/square centimeter.

6. The method of claim 1 wherein said untextured or ungrained skin comprises one of an aliphatic thermoplastic urethane, a blend of aliphatic and aromatic thermoplastic urethanes, or a two layer construction of an outer layer of aliphatic thermoplastic urethane and a base layer of aromatic thermoplastic urethane.

7. The method of claim 1 wherein said untextured or ungrained skin comprises one of a thermoplastic olefin and polyvinylchloride.

8. The method of claim 1 wherein said untextured or ungrained skin has a thickness in the range of about 0.3 to about 1.5 mm.

9. The method of claim 1 wherein said untextured or ungrained skin has a Shore durometer hardness in the range of about 60 to about 90 A.

10. The method of claim 1 wherein said natural fibers comprise one or more of cellulose, lignocellulose, hemp and sisal.

11. The method of claim 1 wherein said synthetic fibers comprise one or more of polypropylene, polyethylene and polyester.

12. The method of claim 1 wherein said web has a basis weight in the range of about 1400 to about 2000 grams per meter squared and a thickness before compressing in the range of about 10 to about 15 mm.

13. The method of claim 1 wherein said natural and said synthetic fibers are present in a weight ratio in the range of about 20% natural and about 80% synthetic to about 80% natural and about 20% synthetic.

14. The method of claim 1 wherein web is heated to a temperature in the range of about 170° C. to about 220° C.

15. The method of claim 1 wherein said synthetic fibers act as a binder for the web of fibers and skin.

16. The method of claim 1 wherein said web and said skin are compressed to a thickness in the range of about 1.8 mm to about 2.5 mm.

17. The method of claim 8 wherein said untextured or ungrained skin has a thickness in the range of about 0.5 to about 0.8 mm.

18. A trim panel molded according to the method of claim 1.
